(19) United States
(12) Patent Application Publication
(10) Pub. No.: US 2017/0230500 A1
(43) Pub. Date: Aug. 10, 2017

(54) A METHOD FOR ROUTING COMMUNICATION CALLS VIA VOIP AND VIA PSTN TO COMMUNICATION DEVICES AND COMPUTER PROGRAM PRODUCTS THEREOF

(71) Applicant: TELEFONICA DIGITIAL ESPAÑA, S.L.U., Madrid (ES)

(72) Inventors: Jorge SERNA POZUELO, Madrid (ES); John Eugene NEYSTADT, Kfar-Saba (IL); Jose Luis URIEN PINEDO, Madrid (ES); Daniel VELASCO BENITO, Madrid (ES)

(73) Assignee: TELEFONICA DIGITIAL ESPAÑA, S.L.U., Madrid (ES)

(21) Appl. No.: 15/501,986

(22) PCT Filed: Jul. 28, 2015
(86) PCT No.: PCT/EP2015/067227

§ 371 Date: Feb. 6, 2017

(30) Foreign Application Priority Data
Aug. 7, 2014 (EP) 14382310.2

(51) Int. Cl. H04M 3/42; H04W 8/02

(52) U.S. Cl. CPC H04M 3/42289; H04M 3/42153; H04W 8/02; H04W 88/06

(57) ABSTRACT

A method for routing communication calls via VoIP and via PSTN to communication devices and computer program products thereof A user (B) having a communication device (H) running an application (D) receives a communication call and upon the user (B) having decided, for a given data network, and before the call being received, which one of a VoIP or PSTN interface be preferred for receiving the call, the method comprising: if the VoIP interface is preferred, routing the communication call by a Communication Call Control Service (F) to the mobile communication application (D) as a VoIP call, and delaying the routing of the communication call over the PSTN interface; or if the PSTN interface is preferred, routing the communication call via the PSTN interface as a PSTN call, and if the result of the PSTN call indicates that said communication device (H) is not registered in the PSTN network further routing the communication call via the VoIP interface. Route and combine VoIP and PSTN incoming call alerts to maximise chance for the call to be answered.

### FIELD OF THE INVENTION

The present invention generally relates to a method for mobile communication applications. In particular, the invention relates to a method and computer programs products for routing communication calls via VoIP and via PSTN to communication devices, and managing communication call alerts, where any of the communication devices may be dual, that is, it can receive the calls by any of these interfaces.

### BACKGROUND OF THE INVENTION

Mobile communication applications, such as Skype®, Viber®, Line®, Tu Go®, provide an ability for receiving incoming communication calls via mobile application, using a Voice/Video Over IP (VoIP) interface (such as Session Initiation Protocol (SIP)), in addition to communication device OS ability to receive native mobile networks call over GSM, VoLTE (Voice over LTE) or other protocols. A key aspect influencing user experience is for communication services to decide whether to route an incoming call to a communication device via native interface (aka Public Switched Telephone Network (PSTN)), VoIP interface or both. Often, when a mobile communication application is not running in the communication device, communication services send a push notification to the communication device enabling the user to react to it and activate the mobile communication application so that it can pick-up a pending incoming call (call pickup).

Communication services usually combine ringing via VoIP and PSTN, but existing methods of combination, all suffer from deficiencies:
ringing both interfaces this creates awkward user experience, when incoming native call interrupts VoIP call being alerted by the mobile communication application.
ringing only one interface may lose calls, in case, when there is no PSTN coverage, or PSTN is more expensive (e.g. roaming) vs free WiFi and the user decides not to pick up the native call.
delaying PSTN call and enabling user to answer in VoIP in case WiFi is not accessible, cause to lose some calls, as caller may abandon the call attempt before recipient user answers delayed PSTN call.

A known patent in the field is US patent U.S. Pat. No. B2-8,457,606, providing techniques allowing choosing among different methods to terminate a call (conventional cellular networks, VoIP calls over non-cellular networks, VoIP calls over cellular data networks, etc.). In said patent, the call is routed to the destination phone number using a first call routing method, and if it fails placing then using a second call routing method. The user can determine routing preferences and the call quality required.

Patent application WO-A1-2009046600 discloses a device and a method for handoff of a VoIP internet telephone call from an IP network to a cellular network and for hand-back of the call to the IP network, in which during or after hand-off of the call an identifier of the hand-off call is obtained and stored and the identifier is used during hand-back of the call to the IP network. The handoff condition could comprise one or more of various factors including, but not limited to, wireless signal strength, current and past transmission and/or reception data error rate, the wireless service provider, quality of service of IP connection, and user manual selection.

It is desirable to provide, therefore, a new method able to route and to combine VoIP and PSTN alerts (e.g. ringing), in a way that maximizes chance for the incoming call to be answered.

### SUMMARY OF THE INVENTION

Present invention provides, in a first aspect, a method for routing communication calls via Voice or Video over IP (VoIP) and via Public Switched Telephone Network (PSTN) to communication devices and for managing communication call alerts, where any of the communication devices may be dual, that is, may receive the communication calls by any of these interfaces.

In the method, a user having at least one communication device running a mobile communication application, configured for said communication device, receives a communication call, wherein the at least one communication device has dual interfaces, a VoIP interface and a PSTN interface, the mobile communication application manages the VoIP interface, and the communication call is routed via a communication call control service.

According to the proposal of the present invention, the user decides, for a given data network, and before the communication call being received (answered), which one of the interfaces is preferred for receiving said communication call, wherein:

a) if the VoIP interface is preferred, the communication call is routed by the communication call control service to the mobile communication application as a VoIP call, and the routing of the communication call over the PSTN interface is delayed; or

b) if the PSTN interface is preferred, the communication call is routed via the PSTN interface as a PSTN call, and if the result of the PSTN call indicates that the communication device is not registered in the PSTN network the communication call is further routed via the VoIP interface.

The communication call may be from another user, but may also be from all kind of communication services, such as those initiating automated calls or managing conference calls.

According to an embodiment, if in step a) (VoIP interface is the preferred interface) the communication call is not answered by the user via the VoIP interface, a communication call notification algorithm is further executed and the delay of the routing of the communication call via the PSTN interface is kept.

According to another embodiment, if in step b) (PSTN interface is the preferred interface) the communication call is not answered via the VoIP interface, a communication call notification algorithm is also executed.

In addition, after the mobile communication application has received the communication call via the VoIP interface, the mobile communication application can check whether the communication call has been also routed to the same device through the PSTN interface. If said checking indicates that the PSTN interface routing was also performed, the mobile communication application, according to an embodiment, stops and rejects the communication call via the VoIP interface, avoiding the redundant alert of the VoIP call to the user and further reports to the communication call control service, if the mobile communication application haven't done it before, that the at least one communication device has dual interfaces. Then, the communication call control service stores the reported information in a database of the communication device for later use.

The communication call control service can store the preferences of the decided interface for said given network in the communication device database, which can be a separate element (e.g. a network element) or be included as part of a Home Subscriber Server (HSS). The decision of the interfaces preferences may be automatically performed, by the mobile communication application, based on at least network quality and/or cost of communication calls over that network, or alternatively, manually by the called user.

In accordance with another aspect, the invention provides a computer program product that has code adapted for carrying out the method of the first aspect when it is executed in a computing device, in a digital signal processor, in a specific circuit integrated in a microcontroller, or any other type of data processing system.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 illustrates the architecture used in the present invention, according to some embodiments, for combining call alerts related to communication calls via VoIP and via PSTN interfaces in a communication device.

FIG. 2 is a diagram showing the different cases, or embodiments, proposed by the invention for routing communication calls via VoIP and via PSTN interfaces to at least one communication device, and managing call alerts, where any of the devices may be dual, that is, it can receive the calls by any of these interfaces.

FIGS. 3a, 3b and 3c are different flow diagrams illustrating, respectively, the three different provided cases. FIG. 3a illustrates the case for No known Dual communication devices and the user preferring to receive calls on VoIP vs PSTN. FIG. 3b illustrates the case for Dual communication devices and the user preferring to receive calls on VoIP vs PSTN. FIG. 3c illustrates the case for Dual communication devices and the user preferring to receive calls on PSTN vs VoIP.

### DETAILED DESCRIPTION OF SEVERAL EMBODIMENTS

The method of the first aspect in general is done by:

Letting a called user B to indicate on which WiFi network(s) (identified by WiFi Service Set Identifier (SSID)) (s)he prefers VoIP ringing.

In the case of user B has a single network device—mobile phone or Tablet/PC without SIM-card as opposed to dual devices, which have both SIM-card based connectivity and WiFi/LAN based connectivity, which can receive calls via multiple networks (e.g. PSTN & VoIP) by detecting such dual-networked devices allowing communication services to choose calling the user B communication device via single interfaces, maximizing user-experience, as ringing a dual devices over multiple-interfaces creates awkward user experience.

Delaying PSTN call, in case dual device is in use, allowing user B to answer in VoIP, as this may take more time, than in PSTN.

Automatically falling back from PSTN to VoIP or from VoIP to PSTN, if user B is not reachable by the preferred decided method.

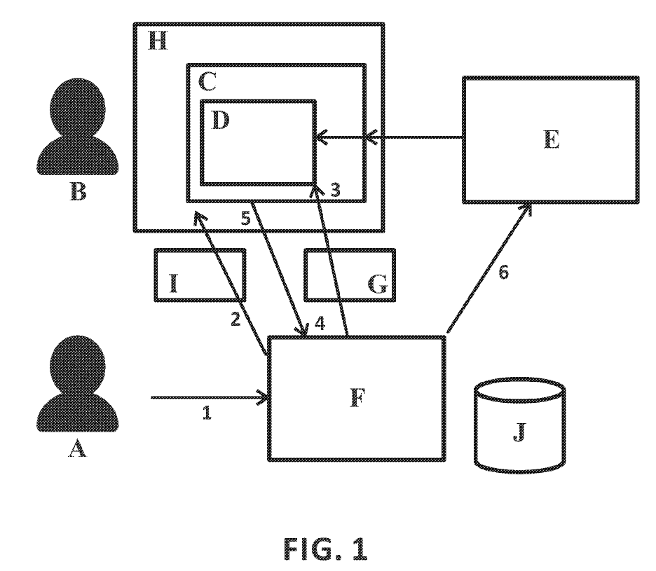

In reference to FIG. 1, a user A (or any type of communication services, such as those initiating automated calls or managing conference calls.) calls another user B, which can use one or more communication devices H running mobile communication applications D. Each one of the communication devices H may optionally have a PSTN interface and a VoIP interface, e.g. SIP. The incoming call to user B is routed via a communication call control service F that can be signaled over a (3) VoIP network G or signaled (2) via a PSTN network I that has a database J of the communication device H. Mobile communication application D can update (4) call communication service F on communication Device H reachability via VoIP, storing the status in the database J. In addition mobile communication applications D detects whether communication device H has dual interfaces, when VoIP and PSTN interfaces from same caller ring simultaneously and updates (5) call the communication call control service F on that fact, which is stored in the database J. Then communication call control service F routes (2, 3) incoming calls to User B via PSTN or VoIP interfaces. Moreover, call control service F can also send (6) Push Notifications via a push notification service E, according to orchestration logic described in detail further.

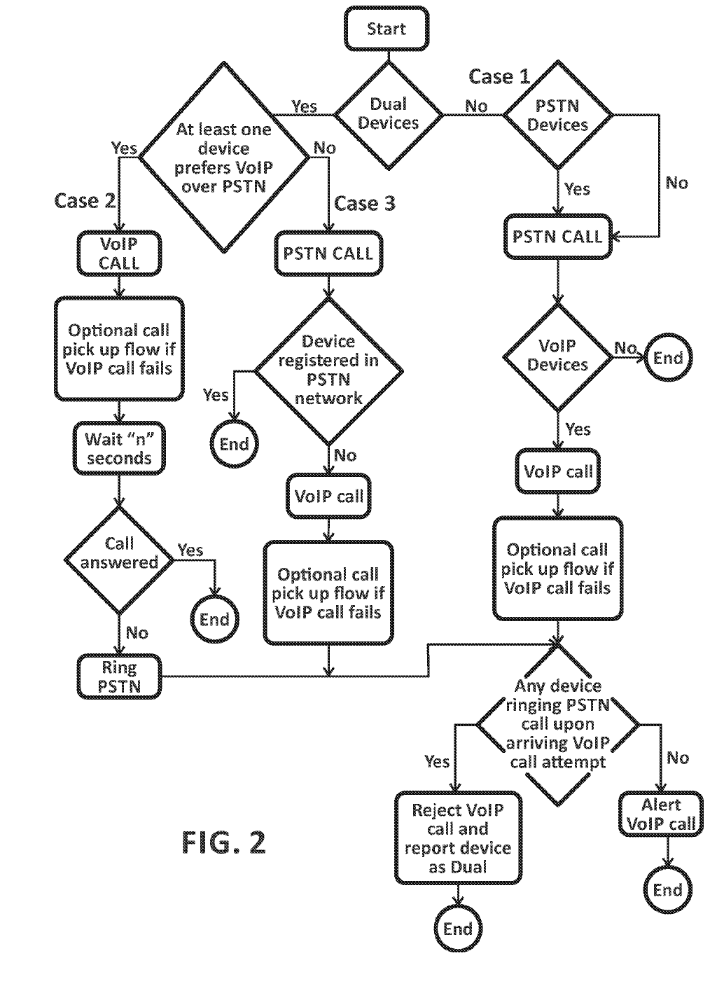

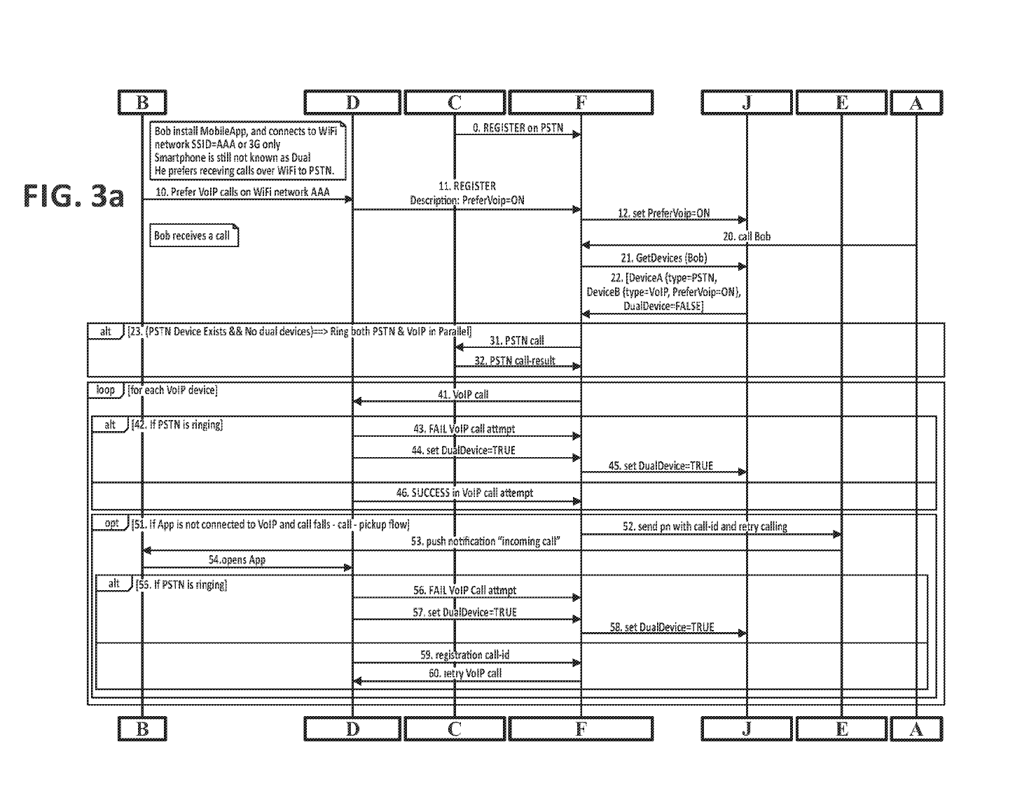

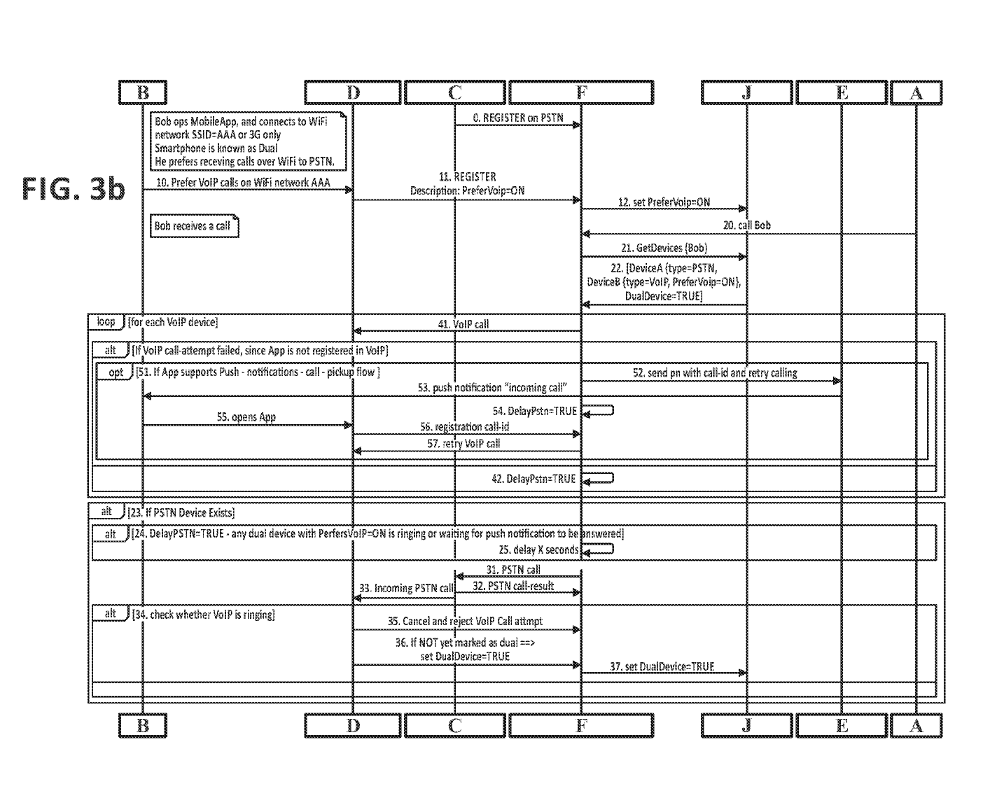

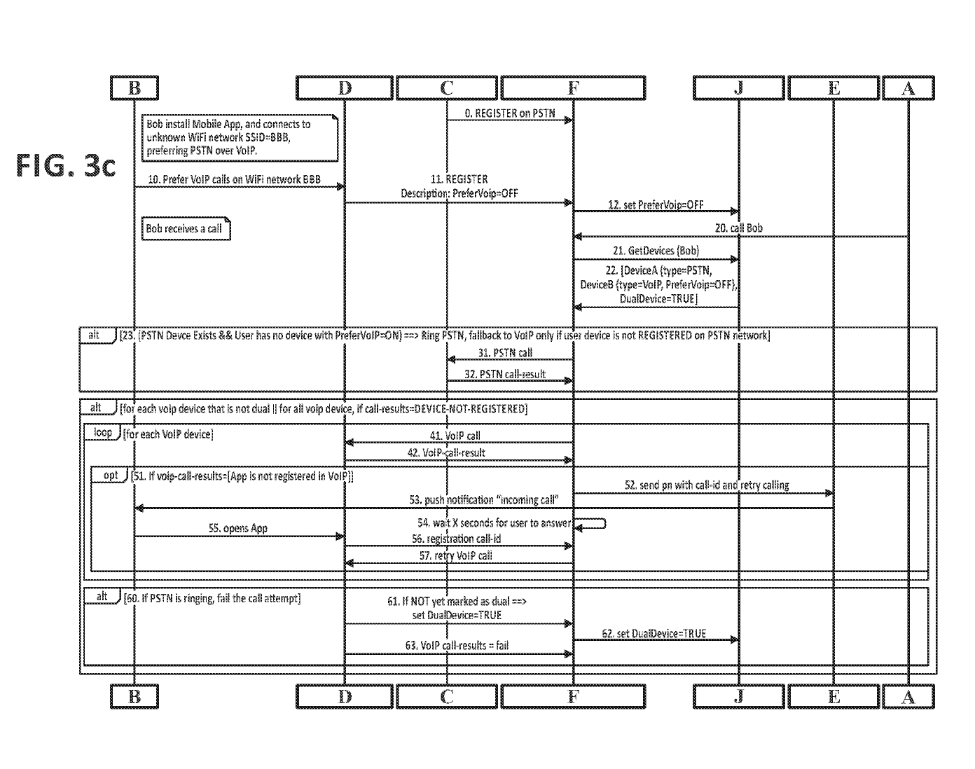

The description of the different embodiments of the invention will now be made with reference to FIGS. 2, 3a, 3b and 3c.

Communication device H keeps a list of “known” WiFi networks, over which user B prefers (10, 11) to receive incoming calls over VoIP interface and delay PSTN call attempts. When communication device H connects or disconnects to a new WiFi network, the mobile communication application D is comparing this network SSID, and registers it (11) to VoIP communication call control service F with a flag of PrefersVol P=ON or PrefersVol P=OFF, indicating respectively that there is a preference of receiving VoIP calls for this communication device H over PSTN or the opposite, what may have been indicated by the user B (10) or determined by the mobile communication application D itself. Communication call control service F can store (12) registration preference (PrefersVol P=ON|OFF) in the database J for later use.

The preference of receiving calls on a given WiFi (or 3G) network can be configured manually by user B or, alternatively, configured automatically by the mobile communication application D based on criteria like network quality, cost of calls over that network, etc.

3GPP's Internet Multimedia Subsystem architecture defines a role of HSS Home Subscriber Server, called also REGISTRAR. This server keeps information about all communication devices H currently registered and reachable in the VoIP network. This solution needs to keep information about user communication devices H (such as whether communication device H is dual), when communication device H is offline, thus additional device database J is used, that can be implemented as part of the HSS or as a separate database.

### No Known Dual-Devices for User B (Case 1 on FIG. 2 and FIG. 3a)

In this embodiment, User B may have multiple PSTN and VoIP enabled communication devices H. User B has a communication device H such as a Smartphone with PSTN and VoIP interfaces. The communication device OS C registers (0) to PSTN network, and user B connects the communication device H to a data network, e.g. WiFi network with SSID named=AAA, and configures (10) the mobile communication application D to prefer to receive VoIP calls vs WiFi on that network. Then, mobile communication application D registers (11) to the communication call control service F, which can store (12) said VoIP preference in the database J. Also, as this is the VoIP communication device that is registered, the communication call control service F is not aware that this is a DUAL VoIP/PSTN communication device, and assumes by default, that User B has two separate communication devices H.

Therefore, upon an incoming call (20) from User A, destined to User B, communication call control service F queries (21) database J and receives (22) indication, on whether User B has any dual communication device H, and a list of two communication devices with the following properties:

1^{st} communication device PSTN

2^{nd} communication device VoIP, with PrefersVol P property set to ON

Indication that User B has no DUAL communication devices.

Then, communication call control service F checks (23), that User B has no DUAL communication devices H, and routes (31) a PSTN call to User B's mobile OS C, receiving back (32) a call attempt result. At that point, for each User B's known VoIP communication device, communication call control service F routes (41) a VoIP call to User B's mobile communication application D. Mobile communication application D upon receiving call attempt checks (42), whether these is an incoming call from the same origin on PSTN interface. If PSTN is ringing, it means that User B actually has DUAL device, so in that case, mobile communication application D rejects (43) VoIP call attempt, avoiding the redundant alert of the VoIP call to user B, reports (44) to communication call control service F that communication device H as dual allowing communication call control service F to store this fact in database J.

Alternatively, if communication device H was not DUAL, mobile communication application D reports (46) to communication call control service F a successful call attempt and starts ringing.

If Communication call control service F receives an error from VoIP network, that indicates that mobile communication application D is not registered to the network, and VoIP communication device supports receiving push notifications to wake-up non-running mobile applications, it can attempt to perform a communication call notification algorithm or call-pickup flow that can be implemented in the following way:

Communication call control service F sends (52) a notification with call-id to notifications service E, the latter forwarding (53) the received notification to User B′s communication device H which alerts User B. User B may respond to the notification, by activating (54) the mobile communication application D. The mobile communication application D, activated via call-pickup flow checks again, whether there is an incoming call from the same origin in PSTN interface. If there is, it rejects VoIP call (56) and reports (57) to communication call control service F that device is dual, allowing the communication call control service F to store (58) this fact in database J.

If there is no PSTN call, the mobile communication application D registers to VoIP network, reporting to Communication call control service F call-id to pick-up. Finally, communication call control service F retries (6) the VoIP call.

### User has a Dual Communication Device and Prefers to Receive Calls on VoIP vs PSTN (Case 2 on FIG. 2 and FIG. 3b)

In this embodiment, it is illustrated how User B has a communication device H such as a Smartphone with PSTN and VoIP interfaces, which was previously detected as DUAL. The communication device OS C, registers (0) to a PSTN network, and User B connects the communication device H to a data network, e.g. WiFi network with SSID named=AAA, and configures (10) the mobile communication application D to prefer to receive VoIP calls vs PSTN on that network. Then, mobile communication application D registers (11) to the communication call control service F, which can store (12) his VoIP preference in the database J.

Upon an incoming call (20) from User A, destined to User B, communication call control service F queries (21) database J and receives (22) indication, on whether User B has any dual communication device H, and a list of two communication devices with the following properties:

1^{st} communication device PSTN

2^{nd} communication device VoIP, with PrefersVol P property set to ON Indication that User B has DUAL communication devices.

Then, communication call control service F checks (23) that User B has DUAL communication devices H, and for each User B's known VoIP communication device, attempts (41) to route a VoIP call to User B's mobile communication application D delaying PSTN call to allow the VoIP call to be answered.

In case communication call control service F detects that VoIP call initiating failed, because VoIP communication device is not registered to VoIP network, and if VoIP communication device supports receiving notifications, communication call control service F can attempt to perform the above described communication call notification algorithm or call-pickup flow and flags DelayPSTN state indicating that PSTN call initiation must be delayed.

In case VoIP call has been successfully initiated, communication call control service F flags DelayPSTN state to delay PSTN call.

If DelayPSTN state was flagged due to successful initiating of ringing of one of the VoIP communication devices, communication call control service F then delays the calling PSTN for a configurable (n) number of seconds, and if the VoIP call is not successfully answered yet, it routes (31) a PSTN call to User B′s communication device H, receiving back (32) a call attempt result, without cancelling ring of VoIP communication devices.

Mobile communication application D upon receiving the call attempt, checks (34) whether this is an incoming call from the same origin on PSTN interface. If PSTN and VoIP are ringing together, it means that User B actually has DUAL communication device H, so in that case the mobile communication application D cancels and rejects (35) VoIP call attempt in that device, avoiding the redundant alert of the VoIP call to user B. If communication device H is not yet marked as DUAL, mobile communication application D reports (36) to communication call control service F that said communication device H is dual, allowing the communication call control service F to store (37) this fact in database J.

### User has Dual Devices, and Indicates that He Prefers to Receive Calls over PSTN vs VoIP (Case 3 on Diagram 2, Call Flow on Diagram 3c)

In this embodiment, User B has a communication device H such as a Smartphone with PSTN and VoIP interfaces, which was previously detected as DUAL. The communication device OS C registers (0) to PSTN network and User B connects the communication device H to an unknown data network, e.g. WiFi network with SSID named=BBB, and configures (10) the mobile communication application D to prefer to receive PSTN calls vs VoIP on that network. Then, the mobile communication application D registers (11) to the communication call control service F, which stores (12) his VoIP preference in the database J.

Upon an incoming call (20) from User A, destined to User B, communication call control service F queries (21) database J and receives (22) indication, on whether User B has any dual communication device H, and a list of two communication devices with the following properties:

1^{st} communication device PSTN

2^{nd} communication device VoIP, with PrefersVol P property set to OFF

Indication that User B has DUAL communication devices.

Then, communication call control service F checks (23), whether User B has a PSTN communication device. In this case User B also has DUAL communication devices H and none of them is configured as PrefersVoIP=ON, so communication call control service F rings (41) User B's communication device H via PSTN interface and receives (32) [PSTN-call-result] from the network.

If [PSTN-call-result] indicates that User B's communication device H was not registered, fallback to VoIP communication devices with PrefersVoIP=OFF can be attempted, rest of the VoIP communication devices (PrefersVoIP=ON) can be rang always.

For each relevant User B's VoIP communication device communication call control service F performs the following logic to attempt VoIP call: communication call control service F attempts (41) to route a VoIP call to User B's mobile communication application D so VoIP call result is received (42) from the network. If Communication call control service F receives an error from VoIP network, that indicates (51) that mobile communication application D is not registered to the network, and VoIP communication device supports receiving notifications, the communication call control service F can attempt to perform the above described communication call notification algorithm or call-pickup flow (52-57).

Finally, the mobile communication application D upon receiving said call attempt, checks (69) whether this is an incoming call from the same origin on PSTN interface. If PSTN is ringing, it means that User B actually has DUAL communication devices H so, in that case, if communication application device is not yet marked as DUAL, mobile communication application D reports (61) to communication call control service F that said communication device H is dual, allowing the call control service F to store (62) this fact in database J. At that moment, the mobile communication application D rejects (63) VoIP call attempt, avoiding the redundant alert of the VoIP call to user B.

The term “computer-readable storage medium” as used herein refers to any tangible medium, such as a disk or semiconductor memory, that participates in providing instructions to a processor for execution. A general purpose computer may be connected to a storage device such as a hard drive, optical media (CD or DVD), disk media, or any other tangible medium from which the general purpose computer can read executable code.

While certain embodiments have been described, these embodiments have been presented by way of example only, and are not intended to limit the scope of the protection. Furthermore, various omissions, substitutions and changes in the form of the methods described herein may be made without departing from the spirit of the protection.

The scope of the invention is defined by the attached claims.

1. A method for routing communication calls via Voice or Video over IP, VoIP, and via Public Switched Telephone Network, PSTN, to at least one communication device, wherein a user having at least one communication device with a mobile communication application receives a communication call, said at least one communication device having dual interfaces, a VoIP interface and a PSTN interface, said mobile communication application managing the VoIP interface, and said communication call being routed via a communication call control service,
characterized in that the user comprises deciding, for a given data network, and before the communication call being received, which one of said interfaces be preferred for receiving this communication call, wherein:
a) if the VoIP interface is preferred comprising routing the communication call by the communication call control service to the mobile communication application as a VoIP call, and delaying the routing of the communication call over the PSTN interface; or
b) if the PSTN interface is preferred comprising routing the communication call via the PSTN interface as a PSTN call, and if the result of the PSTN call indicates that said communication device is not registered in the PSTN network further routing the communication call via the VoIP interface.

2. The method of claim 1, wherein in step a) the communication call is not answered by the user via the VoIP interface, the method further comprising executing a communication call notification algorithm and maintaining delaying the routing of the communication call via the PSTN interface, said communication call pickup algorithm comprising:
the communication call control service sending a push notification including an identification of the communication call to a Notifications Service, the latter forwarding the received notification to the communication device;
upon receiving the notification, the user answering the notification by activating the mobile communication application;
the mobile communication application registering to the VoIP network and further reporting to the communication call control service the communication call identification; and
the communication call control service routing again the communication call via the VoIP interface.

3. The method of claim 1, wherein in step b) the communication call is not answered by the user via the VoIP interface, the method further comprising executing a communication call notification algorithm comprising:
the communication call control service sending a notification including an identification of the communication call to a Notifications Service, the latter forwarding the received notification to the communication device;
upon receiving the notification, the user answering the notification by activating the mobile communication application;
the mobile communication application registering to the VoIP network and further reporting to the communication call control service the communication call identification; and
the communication call control service routing again the communication call via the VoIP interface.

4. The method of claim 1, further comprising, after the mobile communication application having received the communication call via the VoIP interface, checking, by the mobile communication application, whether the communication call being also routed in the PSTN interface, wherein if the result of said checking indicates that the PSTN interface routing is performed, the mobile communication application stopping and rejecting the communication call via the VoIP interface and further reporting to the communication call control service, if haven't done it before, that the at least one communication device has dual interfaces, the communication call control service storing the reported information in a database of the communication device.

5. The method of claim 1, comprising storing, by the communication call control service, preferences of the decided interface for said given network in the communication device database.

6. The method of claim 6, wherein said communication device database is included as part of a Home Subscriber Server, HSS.

7. The method of claim 1, wherein the deciding of the interfaces preferences is automatically performed, by the mobile communication application, based on at least network quality and/or cost of communication calls over that network.

8. The method of claim 1, wherein the deciding of the interfaces preferences is manually performed.

9. A non-transitory computer readable medium storing a program causing a computer to execute a method for routing communication calls via Voice or Video over IP, VoIP, and via Public Switched Telephone Network, PSTN, to at least one communication device, wherein a user having at least one communication device running a mobile communication application receives a communication call, said at least one communication device having dual interfaces, a VoIP interface and a PSTN interface, said mobile communication application managing the VoIP interface, and said communication call being routed via a communication call control service, and upon the user having decided, for a given data network, and before the communication call being received, which one of said interfaces be preferred for receiving the communication call, comprising:
a) if the VoIP interface is preferred, routing the communication call by the communication call control service to the mobile communication application as a VoIP call, and delaying the routing of the communication call over the PSTN interface; or
b) if the PSTN interface is preferred, routing the communication call via the PSTN interface as a PSTN call, and if the result of the PSTN call indicates that said communication device is not registered in the PSTN network further routing the communication call via the VoIP interface.

10. The non-transitory computer readable medium of claim 9, further comprising:
checking, by the mobile communication application, after the mobile communication application having received the communication call via the VoIP interface, whether the communication call being also routed in the PSTN interface;
stopping and rejecting, the mobile communication application, when the result of said checking indicates that the PSTN interface routing is performed, the communication call via the VoIP interface;
reporting, by the mobile communication application to the communication call control service, if haven't done it before, that the at least one communication device has dual interfaces; and
storing, by the communication call control service, the reported information in a database of the communication device.

11. The non-transitory computer readable medium of claim 9 further comprising storing, by the communication call control service, preferences of the decided interface for said given network in the communication device database.
